(19) United States
(12) Patent Application Publication
(10) Pub. No.: US 2016/0132619 A1
(43) Pub. Date: May 12, 2016

(54) ENERGY MANAGEMENT APPARATUS, ENERGY MANAGEMENT METHOD, AND NON-TRANSITORY TANGIBLE COMPUTER READABLE MEDIUM THEREOF

(71) Applicant: Institute For Information Industry, Taipei (TW)

(72) Inventors: Kuei-Peng LEE, Taipei City (TW); Te-Ang CHENG, New Taipei City (TW); Yen-Cheng CHI, Taipei City (TW)

(21) Appl. No.: 14/551,246

(22) Filed: Nov. 24, 2014

(30) Foreign Application Priority Data
Nov. 6, 2014 (TW) 103138478

(51) Int. Cl. G06F 17/50; G05F 1/66

(52) U.S. Cl. CPC G06F 17/5009; G05F 1/66

(57) ABSTRACT

An energy management apparatus, energy management method, and non-transitory tangible computer readable medium thereof are provided. The energy management apparatus receives a plurality of first operation data and environment data, derives a plurality of simulated energy data through energy simulation based on the first operation data and the environment data, calculates an error value between a real environment value and a simulated environment value of the simulated energy data, decides a simulation objective value according to the error value, and decides a plurality of second operation data through energy simulation based on a search algorithm and the simulation objective value. The first operation data correspond to a first time interval, each of the first operation data corresponds to one of a plurality of devices, and the second operation data correspond to a second time interval, and each of the second operation data corresponds to one of the devices.

### PRIORITY

This application claims priority to Taiwan Patent Application No. 103138478 filed on Nov. 6, 2014, which is hereby incorporated herein by reference in its entirety.

### FIELD

The present invention relates to an energy management apparatus, an energy management method, and a non-transitory tangible computer readable medium thereof. More particularly, the present invention relates to an energy management apparatus, an energy management method, and a non-transitory tangible computer readable medium thereof that are based on dynamic energy simulation.

### BACKGROUND

Due to the decreasing resources and the increasing energy prices, energy management has become a concerned topic of the public. Measuring, recording, and analyzing energy consumption conditions in the past and then changing energy consumption behaviors (e.g. changing operation behaviors of the devices within a building) according to the analyzed result is the basic operation principle of energy management mechanism.

Although there are some conventional energy management mechanisms, they simply analyzes energy consumption of one single type of devices. These conventional energy management mechanisms create a regression equation for this type of devices (e.g., regression analysis of electricity consumption on a water chiller, or regression analysis of operation characteristics of a water pump or the like) according to energy consumption data collected within a long period of time (e.g., within one year), estimate an operation mode with the minimum energy consumption of this type of devices, and then control this type of devices according to parameters corresponding to the operation mode with the minimum energy consumption.

Since the technology of creating a regression equation is adopted, history data of important parameters of the devices must be collected at a large scale in the conventional energy management mechanisms. If the parameters taken into consideration are incomplete, the results predicted by the conventional energy management mechanisms would become inaccurate. In addition, since the technology of creating a regression equation is adopted, the conventional energy management mechanisms are not extendable and lack of the flexibility. Furthermore, some factors that influence the electricity consuming behaviors (e.g., the electricity consuming behaviors of large-scale users are mainly influenced by the environmental temperature, the seasons, the design of the building body, or the like) are neglected by the conventional energy management mechanisms, which makes the results predicted by the conventional energy management mechanisms not accurate enough.

Accordingly, an energy management mechanism that takes various factors into account and that is extendable is still in an urgent need in this field.

### SUMMARY

An objective of the present invention includes providing an energy management apparatus. The energy management apparatus in certain embodiments comprises an interface and a processor, wherein the processor is electrically connected to the interface. The interface is configured to receive a plurality of first operation data and a plurality of environment data. The first operation data correspond to a first time interval and each of the first operation data corresponds to one of a plurality of devices. The processor is configured to derive a plurality of simulated energy data through energy simulation based on the first operation data and the environment data, calculate an error value between a real environment value and a simulated environment value of the simulated data, decide a simulation objective value according to the error value, and decide a plurality of second operation data through energy simulation based on a search algorithm and the simulation objective value. The second operation data correspond to a second time interval, each of the second operation data corresponds to one of the devices, and the second time interval is later than the first time interval.

Another objective of the present invention includes providing an energy management method for an electronic apparatus. The energy management method in certain embodiments comprises the following steps of: (a) receiving a plurality of first operation data and a plurality of environment data, wherein the first operation data correspond to a first time interval, and each of the first operation data corresponds to one of a plurality of devices, (b) deriving a plurality of simulated energy data through energy simulation based on the first operation data and the environment data, (c) calculating an error value between a real environment value and a simulated environment value of the simulated data, (d) deciding a simulation objective value according to the error value, and (e) deciding a plurality of second operation data through energy simulation based on a search algorithm and the simulation objective value. The second operation data correspond to a second time interval and each of the second operation data corresponds to one of the devices, and the second time interval is later than the first time interval.

Yet another objective of the present invention includes providing a non-transitory tangible computer readable medium. The non-transitory tangible computer readable medium is stored with a computer program. The computer program executes an energy management method after being loaded into an electronic apparatus. The energy management method in certain embodiments comprises the following steps of: (a) receiving a plurality of first operation data and a plurality of environment data, wherein the first operation data correspond to a first time interval, and each of the first operation data corresponds to one of a plurality of devices, (b) deriving a plurality of simulated energy data through energy simulation based on the first operation data and the environment data, (c) calculating an error value between a real environment value and a simulated environment value of the simulated data, (d) deciding a simulation objective value according to the error value, and (e) deciding a plurality of second operation data through energy simulation based on a search algorithm and the simulation objective value, wherein the second operation data correspond to a second time interval, each of the second operation data corresponds to one of the devices, and the second time interval is later than the first time interval.

The energy management apparatus, the energy management method and the non-transitory tangible computer readable medium thereof according to certain embodiments of the present invention perform energy management on a plurality of devices (i.e., the present invention determines a certain or some operation data/parameters of each of the devices) so that a region that the apparatuses located meets one or more preset objective values. Briefly speaking, the present invention performs the energy simulation according to a plurality of environment data and a plurality of operation data of the devices when operating within a certain time interval. Then, the present invention decides operation data of the devices in a next time interval according to the results of the energy simulation. By using the operation data decided for the next time interval, one or more preset objective values can be achieved in the region where the devices are located.

Since the present invention refers to not only the operation data of the devices when operating within a certain time interval but also the environment data during the process of energy simulation, the accuracy of the energy simulation can be improved. Hence, operation data that will make the devices consume less energy can be decided for the devices. Furthermore, since the present invention does not adopt a technology that requires creation of a regression equation, the time-consuming problem can be avoided. In practical applications, the user or the administrator can set the duration of each time interval depending on his or her needs, so the operation parameters of the devices can be adjusted quickly within a short period of time and energy can be saved efficiently.

The detailed technology and preferred embodiments implemented for the subject invention are described in the following paragraphs accompanying the appended drawings for people of ordinary skill in this field to well appreciate the features of the claimed invention.

### BRIEF DESCRIPTION OF THE DRAWINGS

FIG. 1 illustrates a schematic structural view of a first embodiment of the present invention; and

FIG. 2 illustrates a flowchart diagram of a second embodiment of the present invention.

### DETAILED DESCRIPTION

In the following description, the energy management apparatus, the energy management method, and the non-transitory tangible computer readable medium thereof will be explained with reference to certain example embodiments thereof. However, these example embodiments are not intended to limit the present invention to any specific examples, embodiments, environment, applications, or particular implementations described in these example embodiments. Therefore, description of these example embodiments is only for purpose of illustration rather than to limit the present invention.

It should be appreciated that elements unrelated to the present invention are omitted from depiction in the following embodiments and the attached drawings.

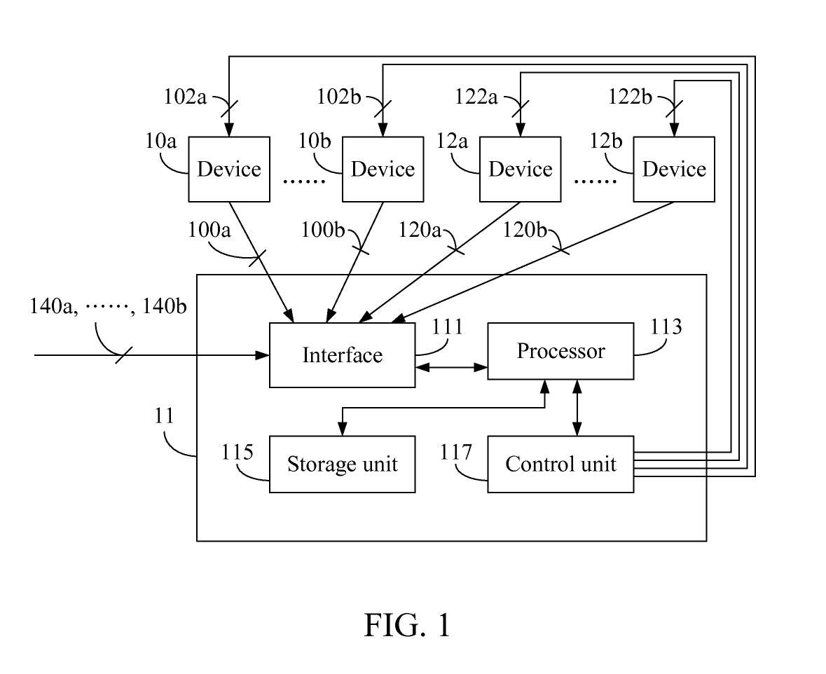

A first embodiment of the present invention is an energy management apparatus 11, and a schematic structural view of which is shown in FIG. 1. The energy management apparatus 11 comprises an interface 111, a processor 113, a storage unit 115, and a control unit 117. The processor 113 is electrically connected with the interface 111, the storage unit 115, and the control unit 117. The interface 111 may be any interface that can receive and transmit a signal. The processor 113 may be any of various processors, central processing units (CPUs), microprocessors, or other computing devices well known to those of ordinary skill in the art. The storage unit 115 may be a memory, a floppy disk, a hard disk, a compact disk (CD), a mobile disk, a magnetic tape, a database, or any other storage medium or electric circuit with the same function and well known to those of ordinary skill in the art. The control unit 117 may be any element that can transmit a message to other devices or any element that can control parameters of other devices.

In this embodiment, a plurality of devices 10a, . . . , 10b, 12a, . . . , 12b are disposed in a region (e.g., a building, or a factory). The devices 10a, . . . , 10b may be of a same type (e.g., water chillers), while the devices 12a, . . . , 12b may be of a same type (e.g., cooling water towers). The energy management apparatus 11 can perform energy management on the devices 10a, . . . , 10b, 12a, . . . , 12b (i.e., the energy management apparatus 11 determines a certain or some operation data/parameters of each of the devices 10a, . . . , 10b, 12a, . . . , 12b) to achieve one or more preset objective values (e.g., to make the temperature of a certain or some positions in the region to be 23° C., and 23° C. is the preset objective value). It should be appreciated that the present invention has no limitation on the number of devices or the number of types of the devices on which the energy management apparatus 11 can perform energy management.

Briefly speaking, the energy management apparatus 11 performs the energy simulation based on a plurality of first operation data 100a, . . . , 100b, 120a, . . . , 120b corresponding to a first time interval and a plurality of environment data 140a, . . . , 140b. The first operation data 100a, . . . , 100b, 120a, . . . , 120b are related to data/parameters of the devices 10a, . . . , 10b, 12a, . . . , 12b when operating within the first time interval. For example, when the device 10a is a water chiller, the first operation datum 100a may comprise an outlet water temperature of the device 10a when operating within the first time interval. As another example, when the device 12a is a cooling water tower, the first operation datum 120a may comprise an outlet water temperature of the device 12a when operating within the first time interval. The energy management apparatus 11 then makes searches and explorations according to the result of the energy simulation to decide a plurality of second operation data 120a, . . . , 102b, 122a, . . . , 122b of the devices 10a, . . . , 10b, 12a, . . . , 12b for operating within a second time interval following the first time interval. The detailed operation mechanism of the energy management apparatus 11 will be described hereinafter.

The interface 111 receives a plurality of first operation data 100a, . . . , 100b, 120a, . . . , 120b. In this embodiment, the interface 111 receives the first operation data 100a, . . . , 100b, 120a, . . . , 120b directly from the devices 10a, . . . , 10b, 12a, . . . , 12b. However, in other embodiments, the interface 111 may receive the first operation data 100a, . . . , 100b, 120a, . . . , 120b indirectly, for example, through a data collecting device, a gateway, or the like. As described above, the first operation data 100a, . . . , 100b, 120a, . . . , 120b correspond to the devices 10a, . . . , 10b, 12a, . . . , 12b respectively, and the first operation data 100a, . . . , 100b, 120a, . . . , 120b all correspond to the first time interval.

The interface 111 also receives a plurality of environment data 140a, . . . , 140b. One or more of the environment data 140a, . . . , 140b may be load data of one or more of the devices 10a, . . . , 10b, 12a, . . . , 12b. One or more of the environment data 140a, . . . , 140b may be weather data (e.g., weather data of a certain season or a certain month), wherein the weather data may be related to the first time interval and/or the second time interval but not limited thereto. When the devices 10a, . . . , 10b, 12a, . . . , 12b are disposed in a building, one or more of the environment data 140a, . . . , 140b may be a model datum of the building, a people load datum of the building, and/or an indoor environment sensing datum of the building (e.g., the dry bulb temperature, the wet bulb temperature, the lighting brightness, or the like). It should be appreciated that the various implementations of the environment data 140a, . . . , 140b described above are only for purpose of illustration. People having ordinary skill in the art can appreciate that the environment data 140a, . . . , 140b may also comprise other data related to the environment where the devices 10a, . . . , 10b, 12a, . . . , 12b are located.

In this embodiment, after the first operation data 100a, . . . , 100b, 120a, . . . , 120b and the environment data 140a, . . . , 140b have been received by the interface 111, the processor 113 stores the first operation data 100a, . . . , 100b, 120a, . . . , 120b and the environment data 140a, . . . , 140b into the storage unit 115. It should be appreciated that, in other embodiments, if the energy management apparatus 11 does not comprise the storage unit 115 or the storage unit 115 comprised in the energy management apparatus 11 has a limited storage space, then the aforesaid operation of storing the first operation data 100a, . . . , 100b, 120a, . . . , 120b and the environment data 140a, . . . , 140b may be omitted.

Then, the processor 113 derives a plurality of simulated energy data (not depicted) through energy simulation based on the first operation data 100a, . . . , 100b, 120a, . . . , 120b and the environment data 140a, . . . , 140b. For example, the processor 113 may perform the energy simulation through use of the EnergyPlus software, which is developed under the sponsorship of the U.S. Department of Energy. If the processor 113 performs the energy simulation through use of the EnergyPlus software, the processor 113 must convert the first operation data 100a, . . . , 100b, 120a, . . . , 120b and the environment data 140a, . . . , 140b into a data format readable by the EnergyPlus software before the energy simulation People having ordinary skill in the art should be familiar with the operation mechanism of the EnergyPlus software and the simulated energy data outputted therefrom; hence, the details are not addressed herein. Briefly speaking, the types of the simulated energy data are related to the types of the first operation data 100a, . . . , 100b, 120a, . . . , 120b and the environment data 140a, . . . , 140b. For example, the simulated energy data may comprise an inlet water temperature, an outlet water temperature, a flow rate, or the like parameter of an evaporator. As another example, the simulated energy data may also comprise the cooling capacity, the water volume, an inlet water temperature, an outlet water temperature, or the like parameter of a condenser.

Then, the processor 113 calculates an error value (not depicted) between a real environment value (not depicted) and a simulated environment value (not depicted) of the simulated data. The error value represents a difference between the real environment where the devices 10a, . . . , 10b, 12a, . . . , 12b are located and the simulated environment. For example, the real environment value is a temperature (e.g., 26° C.) measured at an air outlet of an air conditioner in a real environment where the devices 10a, . . . , 10b, 12a, . . . , 12b are located, the simulated environment value is a temperature (e.g., 25.7° C.) at the air outlet of the air conditioner derived by the processor 113 through energy simulation, and the error value therebetween is 0.3° C.

Then, the processor 113 decides a simulation objective value (not depicted) according to this error value. The processor 113 may firstly compare the error value with a threshold (not depicted), and then decides the simulation objective value according to the comparison result. If the processor 113 determines that the error value is smaller than a threshold, it means that the difference between the real environment and the simulated environment is not significant. Hence, the processor 113 may decide the simulation objective value to be a preset objective value. Otherwise, if the processor 113 determines that the error value is not smaller than the threshold, it means that the difference between the real environment and the simulated environment is significant. Therefore, the processor 113 may decide the simulation objective value according to the error value and a preset objective value. For example, the processor 113 may adjust the preset objective value according to the error value to obtain a value for use as the simulation objective value.

Now, a concrete example will be described. The preset objective value is a temperature that the user or the management staff desires to achieve in the region where the devices 10a, . . . , 10b, 12a, . . . , 12b are located, which has a value of 23° C. The real environment value is a temperature at the air outlet of the air conditioner in the environment where the devices 10a, . . . , 10b, 12a, . . . , 12b are located, which has a value of 26° C. The simulated environment value is a temperature at the air outlet of the air conditioner derived by the processor 113 through energy simulation, which has a value of 25.7° C. According to these conditions, the error value is calculated by the processor 113 to be 0.3° C. If the processor 113 determines that this error value is smaller than the threshold, the processor 113 decides the simulation objective value to be the preset objective value; in other words, the simulation objective value is decided to be 26° C. On the contrary, if the processor 113 determines that this error value is not smaller than the threshold, the processor 113 decides the simulation objective value to be the preset objective value minus the error value; in other words, the simulation objective value is decided to be 25.7° C. It should be appreciated that this exemplary example is only for purpose of illustration. That is, the present invention has no limitation on how to decide the simulation objective value through adjusting the preset objective value according to the error value.

Then, the processor 113 decides the second operation data 102a, . . . , 102b, 122a, . . . , 122b through energy simulation based on a search algorithm and the simulation objective value (e.g., performing the energy simulation through use of the EnergyPlus software that is developed under the sponsorship of the U.S. Department of Energy). For example, the processor 113 may use a Hooke-Jeeves algorithm as a search algorithm. People having ordinary skill in the art should be familiar with the detailed operations of the Hooke-Jeeves algorithm; hence, the details will not be further described herein. At this stage, the processor 113 makes an adjustment on the first operation data 100a, . . . , 100b, 120a, . . . , 120b one at a time (e.g., if the first operation datum 100a is an outlet water temperature of the device 10a when operating within the first time interval, the processor 113 increases or decreases this outlet water temperature), and then performs the energy simulation according to the adjusted first operation datum and the other first operation data to derive an electricity consumption value corresponding to the simulation objective value. For each of the first operation data, the processor 113 may make one or more adjustments, and perform one or more energy simulations to derive one or more electricity consumption values. For the other first operation data, the processor 113 also performs the energy simulation in a similar way. After having made adjustments and performed the energy simulation on each of the first operation data 100a, . . . , 100b, 120a, . . . , 120b, the processor 113 selects the first operation data corresponding to the minimum one of the electricity consumption values as the second operation data 102a, . . . , 102b, 122a, . . . , 122b. As described above, the second operation data 102a, . . . , 102b, 122a, . . . , 122b correspond to a second time interval following the first time interval, and the second operation data 102a, . . . , 102b, 122a, . . . , 122b correspond to the devices 10a, . . . , 10b, 12a, . . . , 12b respectively.

In this embodiment, after the processor 113 has decided the second operation data 102a, . . . , 102b, 122a, . . . , 122b, the control unit 117 controls the devices 10a, . . . , 10b, 12a, . . . , 12b to operate according to the second operation data 102a, . . . , 102b, 122a, . . . , 122b within the second time interval. It should be appreciated that, in other embodiments, the energy management apparatus 11 may not be provided with a control unit 117. For those embodiments, the energy management apparatus 11 will transmit the second operation data 102a, . . . , 102b, 122a, . . . , 122b to the devices 10a, . . . , 10b, 12a, . . . , 12b via the interface 111 so that devices 10a, . . . , 10b, 12a, . . . , 12b can operate according to the second operation data 102a, . . . , 102b, 122a, . . . , 122b within the second time interval.

As can be known from the above descriptions, in order to achieve one or more preset objective values in the region where devices 10a, . . . , 10b, 12a, . . . , 12b are located, the energy management apparatus 11 performs the energy simulation according to the environment data 140a, . . . , 140b and the operation data of the devices 10a, . . . , 10b, 12a, . . . , 12b when operating within a certain time interval, and decides the operation data of the devices 10a, . . . , 10b, 12a, . . . , 12b when operating within the next time interval according to the result of the energy simulation. Through use of the operation data decided by the energy management apparatus 11 for the next time interval, one or more preset objective values can be achieved in the region where devices 10a, . . . , 10b, 12a, . . . , 12b are located.

Since the energy management apparatus 11 considers not only the operation data of the devices 10a, . . . , 10b, 12a, . . . , 12b when operating within a certain time interval but also the environment data 140a, . . . , 140b in the process of energy simulation, the accuracy of the energy simulation can be improved. As a result, operation data that make the devices 10a, . . . , 10b, 12a, . . . , 12b consume less energy can be decided. Furthermore, since the energy management apparatus 11 does not adopt a technology requiring creation of a regression equation, the problem of consuming a too long time is avoided. In addition, in practical applications, the user or the administrator can set the duration of each time interval (e.g., 15 minutes) depending on his or her needs, so the operation parameters of the devices 10a, . . . , 10b, 12a, . . . , 12b can be adjusted quickly within a short period of time to efficiently achieve an energy saving effect.

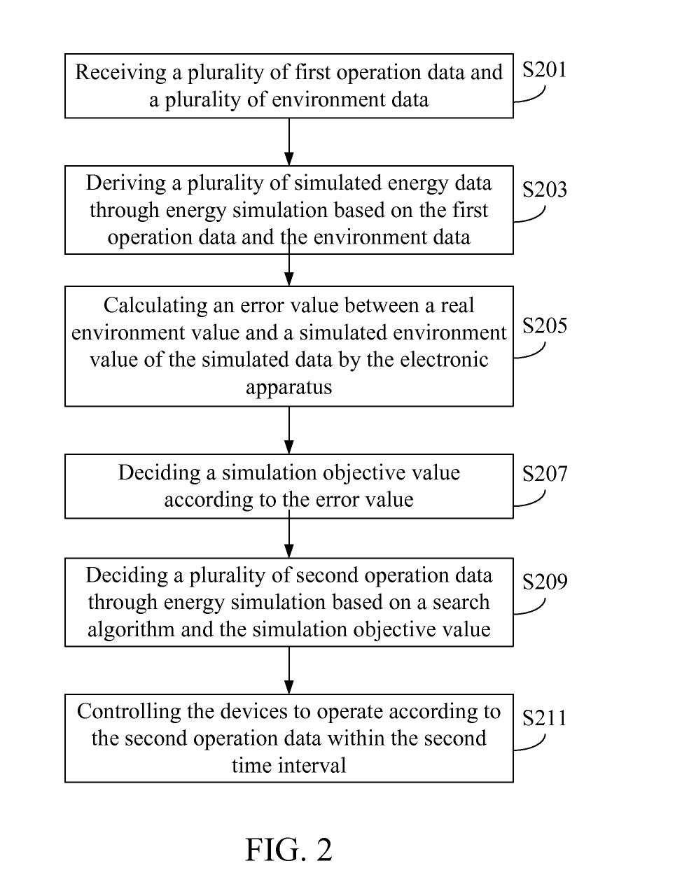

A second embodiment of the present invention is an energy management method for an electronic apparatus (e.g., the energy management apparatus 11 of the first embodiment), wherein a flowchart diagram of which is depicted in FIG. 2.

The energy management method begins from executing step S201 to receive a plurality of first operation data and a plurality of environment data by the electronic apparatus. The first operation data correspond to a first time interval, and each of the first operation data corresponds to one of a plurality of devices. It should be appreciated that, each of the environment data may be a load datum of each of the devices or a weather datum. Additionally, if the devices are disposed in a building, each of the environment data may also be a model datum of the building, a people load datum of the building, and/or an indoor environment sensing datum of the building.

Then, step S203 is executed to derive a plurality of simulated energy data through energy simulation based on the first operation data and the environment data by the electronic apparatus. For example, the energy simulation may be performed through use of EnergyPlus software in the step S203. When the energy simulation is performed through use of the EnergyPlus software in the step S203, another step (not depicted) needs to be executed before the step S203 to convert the first operation data and the environment data into a data format readable by the EnergyPlus software.

Then, step S205 is executed to calculate an error value between a real environment value and a simulated environment value of the simulated data by the electronic apparatus. Afterwards, step S207 is executed to decide a simulation objective value according to the error value by the electronic apparatus. Specifically, if the energy management method determines that the error value is smaller than a threshold in a step (not depicted), the simulation objective value is decided to be a preset objective value in the step S207. If the energy management method determines that the error value is not smaller than a threshold in a step (not depicted), the simulation objective value is decided according to the error value and a preset objective value in the step S207.

Then, step S209 is executed to decide a plurality of second operation data through energy simulation (e.g., performing the energy simulation through use of the EnergyPlus software) based on a search algorithm and the simulation objective value by the electronic apparatus. For example, the search algorithm is a Hooke-Jeeves algorithm. The second operation data correspond to a second time interval, each of the second operation data corresponds to one of the devices, and the second time interval is later than the first time interval. Then, step S211 is executed to control the devices to operate according to the second operation data within the second time interval by the electronic apparatus.

In addition to the aforesaid steps, the second embodiment can also execute all the operations, functions, and steps set forth in the first embodiment. How the second embodiment executes these operations, functions and steps will be readily appreciated by those of ordinary skill in the art based on the explanation of the first embodiment, and thus will not be further described herein.

The energy management method described in the second embodiment may be implemented by a computer program, and the computer program is stored in a non-transitory tangible computer readable medium. After the computer program is loaded into an electronic apparatus (e.g., the energy management apparatus 1 of the first embodiment), the computer program executes the energy management method described in the second embodiment. The non-transitory tangible computer readable storage medium may be an electronic product, such as a read only memory (ROM), a flash memory, a floppy disk, a hard disk, a compact disk (CD), a mobile disk, a magnetic tape, a database accessible to networks, or any other storage media with the same function and well known to those of ordinary skill in the art.

It should be appreciated that, in the specification of the present invention, the terms “first” and “second” as used when describing the first time interval and the second time interval are only used to indicate that the time intervals are different from each other. Similarly, the terms “first” and “second” as used when describing the first operation data and the second operation data are only used to indicate that the operation data correspond to different time intervals.

According to the above descriptions, the present invention can perform energy management on a plurality of devices (i.e., the present invention determines a certain or some operation data/parameters of each of the devices) so that one or more preset objective values are achieved in a region where the apparatuses are located. Briefly speaking, the present invention performs the energy simulation according to a plurality of environment data and operation data of the devices when operating within a certain time interval, and decides operation data of the devices in a next time interval according to results of the energy simulation. Through use of the operation data decided for the next time interval by the present invention, one or more preset objective values can be achieved in the region where the devices are located.

Since not only the operation data of the devices when operating within a certain time interval but also the environment data are taken into account in the process of energy simulation, the accuracy of the energy simulation can be improved. As a result, operation data that make the devices consume less energy can be decided. Furthermore, since the present invention does not adopt a technology requiring creation of a regression equation, the problem of consuming a too long time is avoided. In practical applications, the user or the administrator can set the duration of each time interval depending on his or her needs, so the operation parameters of the devices can be adjusted quickly within a short period of time to efficiently achieve an energy saving effect.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. An energy management apparatus, comprising:
an interface, being configured to receive a plurality of first operation data and a plurality of environment data, the first operation data corresponding to a first time interval, and each of the first operation data corresponding to one of a plurality of devices; and
a processor, being electrically connected to the interface and configured to derive a plurality of simulated energy data through energy simulation based on the first operation data and the environment data, calculate an error value between a real environment value and a simulated environment value of the simulated data, decide a simulation objective value according to the error value, and decide a plurality of second operation data through energy simulation based on a search algorithm and the simulation objective value, wherein the second operation data correspond to a second time interval, each of the second operation data corresponds to one of the devices, and the second time interval is later than the first time interval.

2. The energy management apparatus of claim 1, further comprising:
a control unit, being electrically connected to the processor and the devices and configured to control the devices to operate according to the second operation data within the second time interval.

3. The energy management apparatus of claim 1, further comprising:
a storage unit, being electrically connected to the processor and configured to store the first operation data and the environment data.

4. The energy management apparatus of claim 1, wherein the processor performs the energy simulation through use of EnergyPlus software.

5. The energy management apparatus of claim 4, wherein the processor further converts the first operation data and the environment data into a data format readable by the EnergyPlus software.

6. The energy management apparatus of claim 1, wherein the processor further determines that the error value is smaller than a threshold and the processor decides the simulation objective value to be a preset objective value.

7. The energy management apparatus of claim 1, wherein the processor further determines that the error value is greater than a threshold and the processor decides the simulation objective value according to the error value and a preset objective value.

8. The energy management apparatus of claim 1, wherein the devices are disposed in a building, each of the environment data is one of a model datum of the building, a people load datum of the building, a load datum of each of the devices, an indoor environment sensing datum of the building, and a weather datum.

9. The energy management apparatus of claim 1, wherein the search algorithm is a Hooke-Jeeves algorithm.

10. An energy management method for an electronic apparatus, the method comprising:
(a) receiving a plurality of first operation data and a plurality of environment data, wherein the first operation data correspond to a first time interval and each of the first operation data corresponds to one of a plurality of devices;
(b) deriving a plurality of simulated energy data through energy simulation based on the first operation data and the environment data;
(c) calculating an error value between a real environment value and a simulated environment value of the simulated data;
(d) deciding a simulation objective value according to the error value; and
(e) deciding a plurality of second operation data through energy simulation based on a search algorithm and the simulation objective value, wherein the second operation data correspond to a second time interval, each of the second operation data corresponds to one of the devices, and the second time interval is later than the first time interval.

11. The energy management method of claim 10, further comprising:
controlling the devices to operate according to the second operation data within the second time interval.

12. The energy management method of claim 10, wherein the energy simulation performed in the step (b) is through use of EnergyPlus software.

13. The energy management method of claim 12, further comprising:
converting the first operation data and the environment data into a data format readable by the EnergyPlus software.

14. The energy management method of claim 10, further comprising:
determining that the error value is smaller than a threshold;
wherein the step (d) decides the simulation objective value to be a preset objective value.

15. The energy management method of claim 10, further comprising:
determining that the error value is greater than a threshold;
wherein the step (d) decides the simulation objective value according to the error value and a preset objective value.

16. The energy management method of claim 10, wherein the devices are disposed in a building, each of the environment data is one of a model datum of the building, a people load datum of the building, a load datum of each of the devices, an indoor environment sensing datum of the building, and a weather datum.

17. The energy management method of claim 10, wherein the search algorithm is a Hooke-Jeeves algorithm.

18. A non-transitory tangible computer readable medium, being stored with a computer program, the computer program executing an energy management method after being loaded into an electronic apparatus, and the energy management method comprising:
(a) receiving a plurality of first operation data and a plurality of environment data, wherein the first operation data and the environment data correspond to a first time interval, and each of the first operation data corresponds to one of a plurality of devices;
(b) deriving a plurality of simulated energy data through energy simulation based on the first operation data and the environment data;
(c) calculating an error value between a real environment value and a simulated environment value of the simulated data;
(d) deciding a simulation objective value according to the error value; and
(e) deciding a plurality of second operation data through energy simulation based on a search algorithm and the simulation objective value, wherein the second operation data correspond to a second time interval, each of the second operation data corresponds to one of the devices, and the second time interval is later than the first time interval.
